(19) United States
(12) Patent Application Publication
(10) Pub. No.: US 2024/0132731 A1
(43) Pub. Date: Apr. 25, 2024

(54) SURFACE ZWITTERIONIZED SILICONE ANTIFOULING COATING AND PREPARATION METHOD THEREOF

(71) Applicant: HARBIN ENGINEERING UNIVERSITY, Harbin City (CN)

(72) Inventors: Jun WANG, Harbin City (CN); Zhixin WANG, Harbin City (CN); Dalei SONG, Harbin City (CN); Rongrong CHEN, Harbin City (CN); Qi LIU, Harbin City (CN); Jingyuan LIU, Harbin City (CN); Jing YU, Harbin City (CN); Jiahui ZHU, Harbin City (CN); Gaohui SUN, Harbin City (CN)

(21) Appl. No.: 18/475,634

(22) Filed: Sep. 27, 2023

(30) Foreign Application Priority Data
Oct. 6, 2022 (CN) 202211218610.X

(51) Int. Cl. C09D 5/16; C09D 183/08

(52) U.S. Cl. CPC C09D 5/1637; C09D 5/1681; C09D 183/08

(57) ABSTRACT

Provided are a surface zwitterionized silicone antifouling coating and a preparation method thereof. In the disclosure, hydroxyl-terminated polydimethylsiloxane and N-aminoethyl-3-aminopropyl methyl dimethoxysilane are used as raw materials, and tetramethylammonium hydroxide pentahydrate is used as a catalyst, thereby preparing a series of polydimethylsiloxane resins containing amino side chains in different proportions; then side chain amino modified polydimethylsiloxane is crosslinked and cured by using 3-glycidyloxypropyltrimethoxysilane as a curing agent; after that, the cured silicone coating is soaked in a solution of 1,3-propane sultone in acetone for ionization.

### CROSS-REFERENCE TO RELATED APPLICATION

This patent application claims the benefit and priority of Chinese Patent Application No. 202211218610.X filed with the China National Intellectual Property Administration on Oct. 6, 2022, the disclosure of which is incorporated by reference herein in its entirety as part of the present application.

### TECHNICAL FIELD

The present disclosure relates to the technical field of antifouling coatings, in particular to a surface zwitterionized silicone antifouling coating and a preparation method thereof.

### BACKGROUND

Marine biofouling has a serious impact on marine facilities such as ships, thereby adversely affecting the development of marine industry. To solve this problem, coating an antifouling paint is a common method. Early antifouling paints kill fouling organisms by adding toxic antifouling agents. Among them, organotin-containing antifouling paints have good antifouling effect, but they would release toxic agents, which will accumulate in organisms, thereby affecting the marine ecological environment.

Polydimethylsiloxane has been widely concerned because of its characteristics such as non-toxicity, low surface energy and low roughness, and is considered as a highly promising antifouling paint. However, due to its surface hydrophobicity, polydimethylsioxane is prone to adsorbing substances such as algae, bacteria, and protein, thus forming a biofilm, which in turn leads to an attachment of a large number of fouling organisms. According to Bayer curve, it can be known that introducing hydrophilic groups such as zwitter-ions and hydrophilic ingredients such as polyethylene glycol into a resin could enhance the surface hydrophilicity, thus reducing the surface tension and the adhesion of low-fouling organisms. However, if a hydrophilic ingredient is directly added to the resin, incompatibility between two phases will occur, which leads to the poor mechanical properties of the resin and the detachment of the hydrophilic ingredient, thereby reducing the antifouling effect. Therefore, ionization modifications of silicone matrix resins are used to solve the problem of hydrophilic ingredient detachment.

Chinese patent application CN107955524A (Application No. 201510735804.0) discloses a silicone antifouling paint containing PEG/quaternary ammonium salt and a preparation method thereof. In this application, a quaternary ammonium salt is introduced into a silicone semi-interpenetrating crosslinked network antifouling coating containing PEG, obtaining a silicone antifouling paint containing PEG (polyethylene glycol)/quaternary ammonium salt with improved antifouling ability.

Chinese patent application CN113773436A (Application No. 202111087590.2) discloses an amphiphilic silicone coating and a preparation method and use thereof. In this application, thioglycerol, butyl acrylate and N-vinylpyrrolidone are reacted to obtain a hydrophilic group terminated compound, the hydrophilic group terminated compound is introduced into a main chain of silicone as a side chain to form a comb-like silicone coating, which makes it possible to reduce the adhesion of fouling organisms by the combination of hydrophobicity of the silicone main chain and hydrophilicity of the side chain.

In the present disclosure, the inventor has developed a new silicone antifouling paint starting from different inventive concepts.

### SUMMARY

An object of the present disclosure is to overcome the technical problems present in the prior art, and provide a preparation method and use of a surface modified polydimethylsiloxane resin. In the present disclosure, by synthesizing a hydroxyl-terminated side chain amino-containing polydimethylsiloxane and crosslinking and curing of the hydroxyl-terminated side chain amino-containing polydimethylsiloxane with siloxane containing epoxy group, the crosslinking degree of the resin network could be improved and the catalyst-free curing could be realized. Then zwitter-ions are generated on the polymer surface by surface modification, thus improving the antifouling ability of the coating.

The object of the present disclosure is achieved by the following technical solutions:

The present disclosure provides a method for preparing a surface zwitterionized silicone antifouling coating, comprising the following steps:
step 1, synthesis of a hydroxyl-terminated side chain amino-containing silicone resin:
subjecting finished hydroxyl-terminated polydimethylsiloxane and N-aminoethyl-3-aminopropyl methyl dimethoxysilane to open-chain polymerization in the presence of tetramethylammonium hydroxide as a catalyst, to obtain the hydroxyl-terminated side chain amino-containing silicone resin, which is recorded as component A and has a structure represented by the following formula:

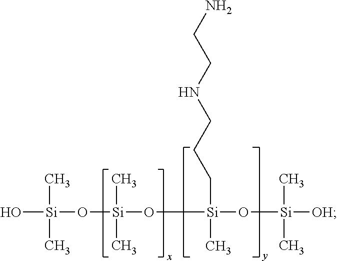

step 2, crosslinking and curing of hydroxyl-terminated side chain amino-containing polydimethylsiloxane resin:
curing the component A with 3-glycidyloxypropyltrimethoxysilane as a curing agent to obtain a cured coating;
step 3, preparation of the surface zwitterionized silicone antifouling coating:
soaking the cured coating in a solution of propane sultone in acetone for surface zwitter-ionization modification.

In some embodiments, in step 1, N-aminoethyl-3-aminopropyl methyl dimethoxy silane is used in an amount of 5-20% by mass, based on a mass of hydroxyl-terminated polydimethylsiloxane.

In some embodiments, in step 1, tetramethylammonium hydroxide is used in an amount of 0.1-0.2% by mass, based on a total mass of a system.

In some embodiments, in step 2, 3-glycidyloxypropyltrimethoxysilane is used in an amount of 2-5%, based on a mass of hydroxyl-terminated side chain amino-containing polydimethylsiloxane resin.

In some embodiments, in step 3, the solution of propane sultone in acetone has a mass concentration of 10%-20%.

The present disclosure also provides a surface zwitterionized silicone resin prepared by any one of the above methods.

The present disclosure also provides use of the surface zwitterionized silicone resin as an antifouling material.

Compared with the prior art, the present disclosure has the following beneficial effects.
1. In the present disclosure, hydroxyl-terminated side chain amino-containing polydimethylsiloxane is cured with a curing agent containing epoxy group. The reaction between amino groups and epoxy groups increases the hydrolysis rate of a silane coupling agent, such that the curing could be performed at ambient temperature and standard pressure.
2. The reaction between amino groups and epoxy groups could make the resin form a higher crosslinking degree, and the generated hydroxyl groups could improve the surface hydrophilicity of the coating.
3. The coating treated with propane sultone is rich in zwitter-ions on the surface, which improves the overall hydrophilicity of the coating and effectively reduces the adhesion of marine fouling organisms such as algae to the coating surface.

### DETAILED DESCRIPTION OF THE EMBODIMENTS

The present disclosure will be described in further detail with reference to examples, without limiting the scope of the present disclosure.

### Example 1

A. Preparation of hydroxyl-terminated side chain amino-containing polydimethylsiloxane resin:

10 g of N-aminoethyl-3-aminopropyl methyl dimethoxysilane was added into a three-necked flask, and deionized water was added thereto and stirred to perform hydrolysis reaction of N-aminoethyl-3-aminopropyl methyl dimethoxysilane to obtain a hydrolyzed product. Then, 200 g of hydroxyl-terminated polydimethylsiloxane was added to the hydrolyzed product, and tetramethylammonium hydroxide pentahydrate was added as a catalyst. The resulting mixture was subjected to grafting reaction while introducing nitrogen to obtain a resin, and the reaction system changed from white to transparent. A viscosity of the resin was adjusted by using water as a terminator to a suitable viscosity. Then the resin was rapidly heated to remove tetramethylammonium hydroxide. The resulting product was subjected to reduced pressure distillation to remove low-boiling substances, obtaining a colorless and transparent hydroxyl-terminated side chain amino-containing polydimethylsiloxane resin with a certain viscosity, recorded as component A.
B. Crosslinking and curing of the hydroxyl-terminated side chain amino-containing polydimethylsiloxane resin:

10 g of component A was added into a 50 mL beaker, and 0.5 g of component B 3-glycidyloxypropyltrimethoxysilane was added thereto and stirred to be uniform to obtain a mixture. The mixture was evenly coated onto a substrate and stood for 24 h at ambient temperature for curing to obtain a cured coating.
C. Preparation of an surface zwitterionized silicone antifouling coating:

The cured coating was soaked in a solution of propane sultone in acetone with a mass concentration of 10% for 24 h to perform zwitter-ionization modification of the coating surface, obtaining the surface zwitterionized silicone coating.

The surface zwitterionized silicone coating and an unmodified silicone coating were soaked in an algae culture solution (diatom concentration greater than 1×10⁶ cells/mL) at exponental phase for 48 h. After that, the samples were soaked in clean artificial seawater and slightly shaken, and diatoms not attached to the surface of the samples were washed away, and then the number of attached diatoms was counted by an optical microscope. The results show that compared with the unmodified silicone coating, the amount of the attached amphora on the modified silicone coating decreased by 86%.

### Example 2

A hydroxyl-terminated side chain amino-containing polydimethylsiloxane resin was prepared by the same method as in Example 1 except that 10 g of N-aminoethyl-3-aminopropyl methyl dimethoxysilane was replaced by 20 g of N-aminoethyl-3-aminopropyl methyl dimethoxysilane.

Performance test was performed according to that of Example 1, and the results show that compared with the unmodified silicone coating, the amount of the attached amphora on the modified silicone coating decreased by 90%.

### Example 3

A hydroxyl-terminated side chain amino-containing polydimethylsiloxane resin was prepared by the same method as in Example 1 except that 10 g of N-aminoethyl-3-aminopropyl methyl dimethoxysilane was replaced by 30 g of N-aminoethyl-3-aminopropyl methyl dimethoxysilane.

Performance test was performed according to that of Example 1, and the results show that compared with the unmodified silicone coating, the amount of the attached amphora on the modified silicone coating decreased by 96%.

### Example 4

A hydroxyl-terminated side chain amino-containing polydimethylsiloxane resin was prepared by the same method as in Example 1 except that 10 g of N-aminoethyl-3-aminopropyl methyl dimethoxysilane was replaced by 40 g of N-aminoethyl-3-aminopropyl methyl dimethoxysilane.

Performance test was performed according to that of Example 1, and the results show that compared with the unmodified silicone coating, the amount of the attached amphora on the modified silicone coating decreased by 98%.

### Comparative Example

This comparative example was a blank sample of pure polydimethylsiloxane (PDMS), and the preparation method thereof was performed as follows:

10 g of unmodified hydroxyl-terminated polydimethylsiloxane was weighed, and 1 g of ethyl orthosilicate and 0.1 g of dibutyltin dilaurate were added thereto to obtain a mixture. After being stirred to be uniform, the mixture was coated onto a substrate and stood for 24 h for curing.

As can be seen from the above examples, the present disclosure provides a method for preparing a surface zwitterionized silicone coating. By grafting zwitter-ions on a surface of the coating, the antifouling effect is improved. According to the results of the examples, compared with the unmodified silicone coating, the surface zwitterionized silicone coating provided by the present disclosure has an inhibition rate of more than 86% on the attachment of amphora, and has a remarkable antifouling effect.

The above is only preferred embodiments of the present disclosure, and it should be pointed out that a person skilled in the art could make several improvements and modifications without departing from the principle of the present disclosure, and these improvements and modifications shall also be regarded as falling within the protection scope of the present disclosure.

In conclusion, the present disclosure discloses a surface zwitterionized silicone antifouling coating and a preparation method thereof. In the present disclosure, hydroxyl-terminated polydimethylsiloxane and N-aminoethyl-3-aminopropyl methyl dimethoxysilane are used as raw materials, and tetramethylammonium hydroxide is used as a catalyst, a series of polydimethylsiloxane resins containing amino side chains in different proportions are prepared; then side chain amino modified polydimethylsiloxane is crosslinked and cured by using 3-glycidyloxypropyltrimethoxysilane as a curing agent; after that, the cured silicone coating is soaked in a solution of 1,3-propane sultone in acetone for ionization. The zwitterionized polydimethylsiloxane retains the property of low surface energy of silicone material, and the zwitter-ion chain on its surface could form a hydration layer to reduce the attachment of marine fouling organisms such as algae.

What is claimed is:

1. A method for preparing a surface zwitterionized silicone antifouling coating, comprising the following steps:
step 1, preparation of a hydroxyl-terminated side chain amino-containing polydimethylsiloxane resin:
adding N-aminoethyl-3-aminopropyl methyl dimethoxy silane and deionized water into a three-necked flask, and hydrolyzing the N-aminoethyl-3-aminopropyl methyl dimethoxy silane to obtain a hydrolyzed product;
subjecting the hydrolyzed product to first reduced pressure distillation to remove low-boiling substances generated by the hydrolyzing to obtain a distilled product;
adding hydroxyl-terminated polydimethylsiloxane to the distilled product, and adding tetramethylammonium hydroxide pentahydrate as a catalyst thereto to obtain a first mixture, and subjecting the first mixture to grafting reaction while introducing nitrogen to obtain a resin, wherein during the grafting reaction, a reaction system changes from white to transparent;
adjusting a viscosity of the resin with water as a terminator, and then rapidly heating the resin until tetramethylammonium hydroxide in the reaction system is removed to obtain a heated resin; and
subjecting the heated resin to second reduced pressure distillation to remove low-boiling substances to obtain the hydroxyl-terminated side chain amino-containing polydimethylsiloxane resin which is colorless, recorded as component A, wherein the component A has a structure represented by the following formula: 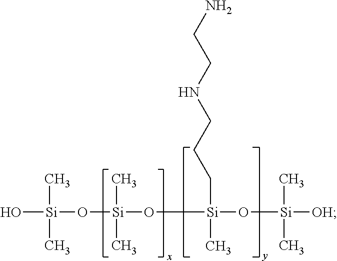
where N-aminoethyl-3-aminopropyl methyl dimethoxy silane is used in an amount of 5-20% by mass, based on a mass of hydroxyl-terminated polydimethylsiloxane; hydroxyl-terminated polydimethylsiloxane has a viscosity of 5000 cs; and the catalyst tetramethylammonium hydroxide pentahydrate is used in an amount of 0.1-0.2% by mass, based on a total mass of a system,
step 2, crosslinking and curing of the hydroxyl-terminated side chain amino-containing polydimethylsiloxane resin:
adding the component A into a 50 mL beaker, and adding component B 3-glycidyloxypropyltrimethoxysilane thereto; stirring the component A and the component B to be uniform to obtain a second mixture; evenly coating the second mixture onto a substrate; and curing the second mixture by standing at ambient temperature for 24 h to obtain a cured hydroxyl-terminated side chain amino-containing polydimethylsiloxane coating, where the component B is used in an amount of 5-10% by mass, based on a mass of the component A, and the curing is performed for 24 h; and
step 3, preparation of the surface zwitterionized silicone antifouling coating:
soaking the cured hydroxyl-terminated side chain amino-containing polydimethylsiloxane coating in a solution of propane sultone in acetone for surface zwitter-ionization.

2. The method of claim 1, wherein hydrolyzing N-aminoethyl-3-aminopropyl methyl dimethoxy silane is performed at a temperature of 70° C., the first reduced pressure distillation is performed for 1 h, the grafting reaction is performed at a temperature of 105-110° C. for 4-5 h, and tetramethylammonium hydroxide is removed at a temperature of 145° C. for 1 h.

3. The method of claim 1, wherein in step 3, propane sultone is used in an amount of 10-20% by mass, based on a mass of acetone.

4. A surface zwitterionized silicone antifouling coating, which is prepared by the method of claim 1.

5. The surface zwitterionized silicone antifouling coating of claim 4, wherein hydrolyzing N-aminoethyl-3-aminopropyl methyl dimethoxy silane is performed at a temperature of 70° C., the first reduced pressure distillation is performed for 1 h, the grafting reaction is performed at a temperature of 105-110° C. for 4-5 h, and tetramethylammonium hydroxide is removed at a temperature of 145° C. for 1 h.

6. The surface zwitterionized silicone antifouling coating of claim 4, wherein in step 3, propane sultone is used in an amount of 10-20% by mass, based on a mass of acetone.
